(19) United States
(12) Patent Application Publication
(10) Pub. No.: US 2025/0130710 A1
(43) Pub. Date: Apr. 24, 2025

(54) ELECTRONIC DEVICE AND CONTROL METHOD

(71) Applicant: SONY SEMICONDUCTOR SOLUTIONS CORPORATION, KANAGAWA (JP)

(72) Inventor: MAKOTO MATSUZAKI, KANAGAWA (JP)

(21) Appl. No.: 18/833,763

(22) PCT Filed: Jan. 6, 2022
(86) PCT No.: PCT/JP2023/002350

§ 371 Date: Jul. 26, 2024

(30) Foreign Application Priority Data
Feb. 7, 2022 (JP) 2022-017063

(51) Int. Cl. G06F 3/0488; G06F 3/16

(52) U.S. Cl. CPC G06F 3/0488; G06F 3/165

(57) ABSTRACT

The present disclosure relates to an electronic device and a control method capable of detecting a continuous long press state. Provided is an electronic device including: an operation unit that outputs an operation signal according to a touch operation by a user; a detection unit that detects a command according to the touch operation on the basis of the output operation signal; and a control unit that executes processing according to the detected command, in which in a case of detecting a long press operation as the touch operation, the detection unit initializes an internal state and notifies the control unit of an interrupt according to a continuous long press state when detecting a break of the command, and the control unit executes processing according to the notified interrupt. The present disclosure can be applied to, for example, an electronic device such as a wireless earphone.

### TECHNICAL FIELD

The present disclosure relates to an electronic device and a control method, and more particularly to an electronic device and a control method capable of detecting a continuous long press state.

### BACKGROUND ART

In recent years, electronic devices that perform an operation according to a touch operation on an operation surface by a user have become widespread (see, for example, Patent Document 1). There are various types of touch operations, and a long press operation, which is an operation in which a user's finger touches the operation surface for a certain period of time and then releases the operation surface, may be performed.

### CITATION LIST

### Patent Document

Patent Document 1: Japanese Patent Application Laid-Open No. 2009-032258

### SUMMARY OF THE INVENTION

### Problems to be Solved by the Invention

In a case where a long press operation is detected as a touch operation, there is a need for a technique for detecting a continuous long press state as well as detecting that a long press operation has been performed.

The present disclosure has been made in view of such a situation, and enables detection of a continuous long press state.

### Solutions to Problems

An electronic device according to one aspect of the present disclosure is an electronic device including: an operation unit that outputs an operation signal according to a touch operation by a user; a detection unit that detects a command according to the touch operation on the basis of the output operation signal; and a control unit that executes processing according to the detected command, in which in a case of detecting a long press operation as the touch operation, the detection unit initializes an internal state and notifies the control unit of an interrupt according to a continuous long press state when detecting a break of the command, and the control unit executes processing according to the notified interrupt.

A control method according to one aspect of the present disclosure is a control method in an electronic device including: an operation unit that outputs an operation signal according to a touch operation by a user; a detection unit that detects a command according to the touch operation on the basis of the output operation signal; and a control unit that executes processing according to the detected command, the control method including: in a case where the detection unit detects a long press operation as the touch operation, initializing an internal state and notifying the control unit of an interrupt according to a continuous long press state when the detection unit detects a break of the command; and executing, by the control unit, processing according to the notified interrupt.

An electronic device and a control method according to one aspect of the present disclosure include: an operation unit that outputs an operation signal according to a touch operation by a user; a detection unit that detects a command according to the touch operation on the basis of the output operation signal; and a control unit that executes processing according to the detected command. In a case where a long press operation is detected as the touch operation by the detection unit, an internal state is initialized and the control unit is notified of an interrupt according to a continuous long press state when a break of the command is detected, and processing according to the notified interrupt is executed by the control unit.

Note that the electronic device according to one aspect of the present disclosure may be an independent device or an internal block constituting one device.

### BRIEF DESCRIPTION OF DRAWINGS

FIG. 1 is a block diagram illustrating a configuration example of an electronic device 10 to which the present disclosure is applied.

FIG. 2 is a block diagram illustrating a configuration example of a detection unit 12A.

FIG. 3 is a diagram illustrating an example of a circuit implemented by the detection unit 12A.

FIG. 4 is a timing chart illustrating an operation in a case where the detection unit 12A detects a continuous long press state.

FIG. 5 is a timing chart illustrating an operation in a case where continuation of a long press state is determined by polling processing by software.

FIG. 6 is a block diagram illustrating a configuration example of a detection unit 12B.

FIG. 7 is a timing chart illustrating an operation in a case where the detection unit 12B repeatedly detects a continuous long press state.

FIG. 8 is a timing chart illustrating an operation in a case where the detection unit 12B dynamically changes an initial state in the continuous long press state.

FIG. 9 is a diagram illustrating an external configuration example of a wireless earphone 10A to which the present disclosure is applied.

FIG. 10 is a block diagram illustrating a configuration example of the wireless earphone 10A.

FIG. 11 is a flowchart illustrating a flow of volume up processing.

FIG. 12 is a timing chart illustrating a timing of the volume up processing when an initial value of a counter is dynamically changed in the continuous long press state.

FIG. 13 is a diagram illustrating a change in a volume value by the volume up processing.

FIG. 14 is a flowchart illustrating a flow of FF processing.

FIG. 15 is a timing chart illustrating a timing of the FF processing when the initial value of the counter is dynamically changed in the continuous long press state.

FIG. 16 is a diagram illustrating a change in a step width of the FF processing.

### MODE FOR CARRYING OUT THE INVENTION

### <Device Configuration>

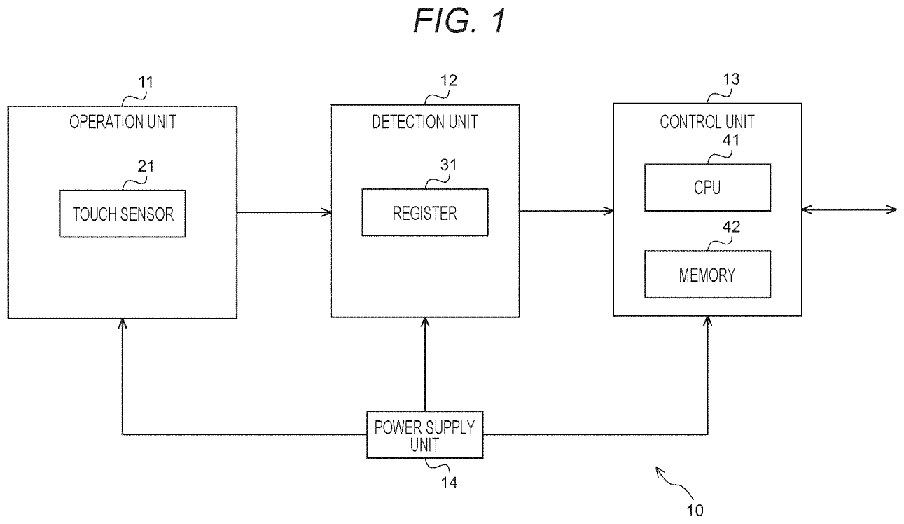

FIG. 1 is a block diagram illustrating a configuration example of an electronic device 10 to which the present disclosure is applied.

The electronic device 10 is a device that operates according to a user's touch operation. In FIG. 1, the electronic device 10 includes an operation unit 11, a detection unit 12, a control unit 13, and a power supply unit 14.

The operation unit 11 detects an operation (touch operation) caused by a user's finger or the like touching an operation surface (a housing surface or the like). The operation unit 11 is configured as a user interface circuit including, for example, a capacitive or pressure-sensitive touch sensor 21. The operation unit 11 outputs a sequence of signals (operation signals) according to the touch operation detected by the touch sensor 21 to the detection unit 12.

The sequence of the operation signals includes a value (for example, L or 0 level) indicating a state where there is no touch operation on the operation surface and a value (for example, H or 1 level) indicating a state where there is a touch operation on the operation surface. For example, a continuous H-level signal sequence can be output while the user's finger is in contact with the operation surface. Alternatively, it may be configured to continuously output a pulse-like signal sequence according to a predetermined operation clock.

The detection unit 12 detects a command for the control unit 13 on the basis of the sequence of the operation signals output from the operation unit 11. The detection unit 12 is typically configured as a command detection circuit that does not include a high-performance arithmetic circuit such as a central processing unit (CPU) capable of executing a program so as to suppress power consumption as low as possible. Furthermore, the detection unit 12 acquires or calculates the time and the number of times of touch operations on the basis of the sequence of the operation signals, and writes and holds the time and the number of times of the touch operations in a register 31 at a predetermined timing. The register 31 is configured to be referenceable by the control unit 13.

In a case where the L level continues for a predetermined time after the H level in the sequence of the operation signals, the detection unit 12 recognizes that some command is included in the sequence up to that time. That is, the detection unit 12 detects the command in the sequence of the operation signals by detecting a break of the touch operation according to a length of the duration of a no-signal state in the sequence of the operation signals. In the case of determining that the command is detected, the detection unit 12 outputs a command detection signal to the control unit 13.

The control unit 13 comprehensively controls the operation of the electronic device 10. The control unit 13 is configured as a processor module including a CPU 41 and a memory 42 used for the CPU. The memory 42 stores a control program, various data, and the like.

The control unit 13 executes a control program and realizes a predetermined function according to the execution of the control program. For example, in the case of receiving the command detection signal output from the detection unit 12, the control unit 13 fetches (acquires) the content held in the register 31 to perform command interpretation processing, and outputs a command obtained as a result to a target circuit (communication module or the like).

The power supply unit 14 supplies necessary power to each unit in the electronic device 10. For example, the power supply unit 14 is a secondary battery such as a lithium ion battery. Alternatively, the power supply unit 14 may include a wireless power supply unit (not illustrated) that can be filled by wireless power supply from the outside.

### <First Example of Detection Unit Configuration>

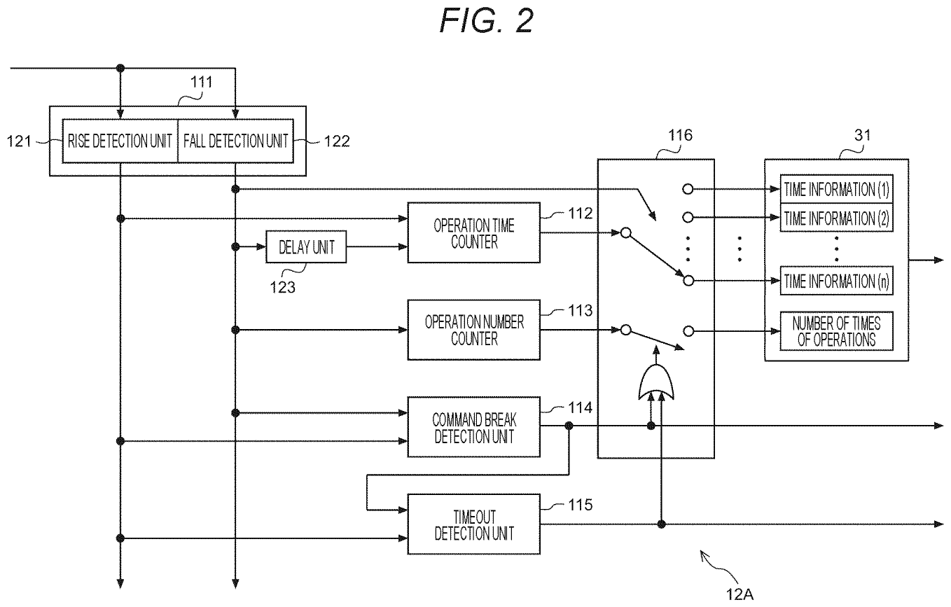

FIG. 2 is a block diagram illustrating a first example of the configuration of the detection unit 12 in FIG. 1.

As illustrated in FIG. 2, in addition to the register 31, a detection unit 12A includes an edge detection unit 111, an operation time counter 112, an operation number counter 113, a command break detection unit 114, a timeout detection unit 115, and an output control unit 116.

The edge detection unit 111 detects rising and falling edges of a signal in the sequence of the operation signals. The edge detection unit 111 includes a rise detection unit 121 and a fall detection unit 122.

The rise detection unit 121 detects a rising edge (from the L level to the H level) of the signal in the sequence of the operation signals, and outputs a rise detection signal in the case of detecting the rising edge. The rise detection signal is output to the operation time counter 112, the command break detection unit 114, and the timeout detection unit 115.

The fall detection unit 122 detects a falling edge (from the H level to the L level) of a signal in the sequence of the operation signals, and outputs a fall detection signal in the case of detecting the fall. The fall detection signal is output to (a delay unit 123 in the preceding stage of) the operation time counter 112, the operation number counter 113, the command break detection unit 114, and the output control unit 116.

The operation time counter 112 is a counter that measures the time when the user performs the touch operation, and holds the measured time as the time of the touch operation. The held time of the touch operation is read by detecting a fall of the operation signal. That is, when receiving the rise detection signal from the rise detection unit 121, the operation time counter 112 measures an elapsed time until receiving the fall detection signal from the fall detection unit 122 using this as a trigger.

In a case where a tap operation by the user is too early (the contact time is very short), the time of the touch operation cannot be correctly measured even though the touch operation is performed. Therefore, the delay unit 123 that delays the fall detection signal is provided.

The operation number counter 113 counts up a count value of the counter and temporarily holds the count value every time the fall detection signal is received from the fall detection unit 122. The held count value is output with detection of a command break by the command break detection unit 114 or detection of a timeout by the timeout detection unit 115 described later as a trigger. When the count value is read, the operation number counter 113 resets the count value of the counter.

The command break detection unit 114 detects a break of a command in the sequence of the operation signals. That is, when receiving the fall detection signal from the fall detection unit 122, the command break detection unit 114 measures the time when an L level state has elapsed, using the fall detection signal as a trigger. The measurement by the command break detection unit 114 is temporarily reset by receiving a rise detection signal from the rise detection unit 121.

In a case where it is determined that the measured elapsed time exceeds a predetermined threshold, the command break detection unit 114 assumes that a command input by the user's touch operation has been completed, and outputs a command detection signal. On the other hand, in a case where the rise detection signal is received before the measured elapsed time exceeds the predetermined threshold, the command break detection unit 114 determines that the command input is not completed, and resets measurement time.

As described above, the command break detection unit 114 detects the command break by determining whether or not a predetermined time has elapsed since the last fall of the operation signal. For example, in a case where the user's touch operation is a combination of some operation actions such as a double tap operation, when the next tap is performed immediately after the tap, the command break detection unit 114 determines that the user's touch operation is still continuing.

The command detection signal from the command break detection unit 114 is output to the control unit 13 along with the timeout detection unit 115 and the output control unit 116. When receiving the command detection signal, the control unit 13 refers to the register 31, fetches the content held in the register 31, executes the command interpretation processing, and outputs an interpreted command.

The timeout detection unit 115 monitors whether or not one touch operation (For example, a double tap operation is one touch operation.) has been performed within a predetermined effective operation time, and outputs a timeout signal in a case where the predetermined effective operation time has elapsed.

That is, when receiving a first rise detection signal from the rise detection unit 121, the timeout detection unit 115 measures the elapsed time using this as a trigger. In a case where it is determined that the elapsed time exceeds a predetermined threshold, the timeout detection unit 115 outputs a timeout signal. Furthermore, the timeout detection unit 115 resets measurement time when receiving the command detection signal from the command break detection unit 114.

The timeout signal from the timeout detection unit 115 is output to the control unit 13 along with the output control unit 116. When receiving the timeout signal, the control unit 13 refers to the register 31 instead of the command detection signal, fetches the content held in the register 31, executes the command interpretation processing, and outputs an interpreted command.

The output control unit 116 performs control such that the time of the touch operation measured by the operation time counter 112 and the number of times of the touch operations measured by the operation number counter 113 are output to a predetermined output destination of the register 31 at predetermined timings.

For example, every time the fall detection signal is received from the fall detection unit 122, the output control unit 116 selectively and sequentially switches an output destination of the time of the touch operation read from the operation time counter 112. As a result, the time of the touch operation (time information (1) to (n)) is sequentially written in a specific storage area of the register 31.

Furthermore, when receiving the command detection signal from the command break detection unit 114, the output control unit 116 performs control so that the number of times of the touch operations read from the operation number counter 113 is output to the register 31. As a result, the number of times of touch operations (the number of times of operations) is written and updated in a specific storage area of the register 31.

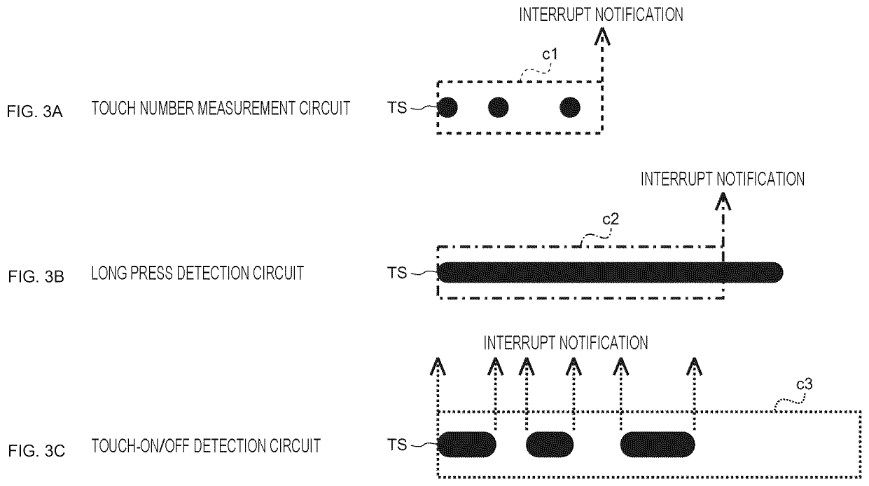

In the detection unit 12A having the hardware (HW) configuration as described above, when a command to the control unit 13 including the CPU 41 is detected, for example, it is possible to operate as any circuit or all circuits of three circuits as illustrated in FIG. 3. That is, the detection unit 12A can realize at least one of a touch number measurement circuit, a long press detection circuit, and a touch-on/off detection circuit.

As illustrated in A of FIG. 3, in the touch number measurement circuit, the operation number counter 113 updates the number of times of operations held in the register 31, thereby measuring the number of times of touch operations within a predetermined period. Here, the command break detection unit 114 makes a notification of an interrupt of the command detection signal, so that the CPU 41 can output a command according to the number of times of operations held in the register 31.

The interrupt is a request received by the CPU 41 from the detection unit 12. Since the detection unit 12 is configured as hardware, it can also be said to be a hardware interrupt (external interrupt). The CPU 41 has a function for processing an interrupt.

In A of FIG. 3, a black circle TS indicates a state in which the user's finger touches the operation surface, that is, a touch state with a short contact time, and a broken line rectangle c1 indicates that the detection unit 12A operates as a touch number measurement circuit when a direction from the left to the right in the drawing is a time direction. In A of FIG. 3, the number of times of touches, which is three times, is measured as the number of times of the touch state within a certain period (for example, one second) at the timing when a notification of the interrupt is made.

As illustrated in B of FIG. 3, the long press detection circuit detects a long press operation that is an operation with a long contact time of a user's finger. In the detection unit 12A, as a method of realizing the long press detection circuit, there is a method of generating an interrupt at the time of expiration of the counter of the operation time counter 112.

In B of FIG. 3, a horizontal bar TS represents a touch state in which a contact time is long, a dashed-dotted line rectangle c2 represents that the detection unit 12A operates as a long press detection circuit, and when the touch state continues in a certain period (for example, 2 seconds or 3 seconds), a long press operation is detected, and a notification of an interrupt of a command detection signal is made at that timing.

As illustrated in C of FIG. 3, the touch-on/off detection circuit detects a state (touch-on) when the user's finger touches the operation surface and a state (touch-off) when the user's finger moves away from the operation surface. In the detection unit 12A, as a method of realizing the touch-on/off detection circuit, there is a method of generating an interrupt when the command break detection unit 114 receives a rise detection signal from the rise detection unit 121 or a fall detection signal from the fall detection unit 122.

In C of FIG. 3, a variable point TS including a short point and a long point represents repetition of touch states with different touch times, a dotted rectangle c3 represents that the detection unit 12A operates as a touch-on/off detection circuit, and a notification of an interrupt is continuously made according to timings at which the start (touch-on) and the end (touch-off) of each touch state are detected.

As described above, the detection unit 12A having the hardware configuration illustrated in FIG. 2 can operate as at least one of the touch number measurement circuit, the long press detection circuit, and the touch-on/off detection circuit.

### Problem

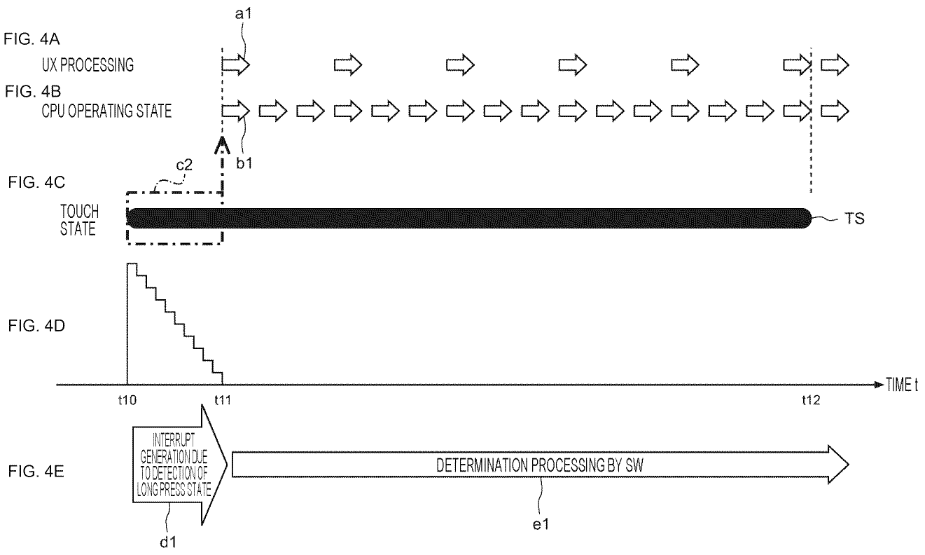

FIG. 4 is a timing chart illustrating an operation in a case where the detection unit 12A in FIG. 2 detects a continuous long press state.

In A of FIG. 4, a timing at which UX processing is executed is indicated by an arrow al. The user experience (UX) processing is processing for providing the experience that the user can obtain through the electronic device 10. For example, in a case where the electronic device 10 has a function related to reproduction of music content, processing such as adjustment of a sound volume and a reproduction speed of music is executed as the UX processing. In B of FIG. 4, a timing at which the CPU 41 enters an operating state is indicated by an arrow b1.

In C of FIG. 4, a horizontal bar TS indicates whether the user's finger is in a state of touching the operation surface (touch state). D of FIG. 4 illustrates measurement of the operation time by the operation time counter 112. Here, a case where a down counter is used as a configuration for realizing detection of a long press state by hardware (HW) is exemplified, but another configuration such as an up counter may be used.

As illustrated in C and D of FIG. 4, when the touch state is entered at time t10, the operation time counter 112 starts counting. Since the horizontal bar TS is continuous and the touch state is a long press state, the operation time counter 112 continuously decrements a counter value during a period in which the long press state continues. Thereafter, when the counter of the operation time counter 112 expires at time t11, an interrupt of the command detection signal can be generated. That is, as indicated by a dashed-dotted line rectangle c2, the detection unit 12A operates as a long press detection circuit, and performs an interrupt notification at the time of expiration of the counter.

In E of FIG. 4, the timing at which internal processing of the electronic device 10 is executed is indicated by an arrow d1 and an arrow e1. That is, when the long press state is detected between time t10 and time t11 (for example, for 3 seconds), an interrupt due to detection of the long press state can be generated as indicated by the arrow d1, but the long press state cannot be detected even if the long press state continues after time t11. In other words, in a case where the detection unit 12A operates as a long press detection circuit, a long press operation can be detected, but a continuous long press state cannot be detected.

In a case where the UX processing for the continuous long press state is realized, it is necessary to determine whether or not the long press state is continued by polling processing as determination processing by software (SW) as indicated by the arrow e1. In A and B of FIG. 4, when a temporal interval of the arrow al and a temporal interval of the arrow b1 are compared, the interval of the arrow b1 is shorter, but the CPU 41 can execute the UX processing according to the long press state by executing the polling processing and periodically monitoring the touch state.

However, in a case where the polling processing by software is used, there may be disadvantages such as an increase in power consumption and an increase in complexity regarding software design and implementation. Furthermore, in a case where a series of UX processing is completed at a timing when the end of the long press state is determined by the polling processing by software, there is a possibility that the timing is different from the actual end time (time t12) of the long press state due to a deviation from the polling interval.

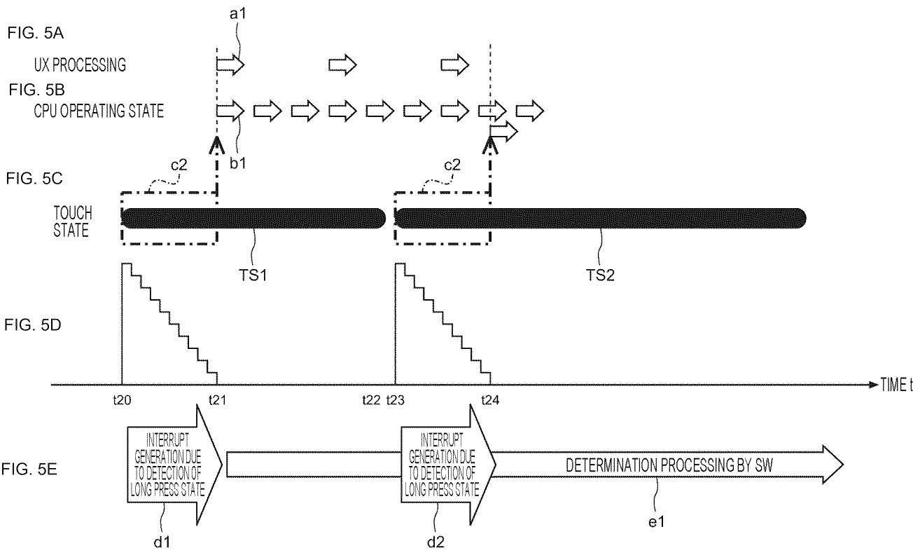

FIG. 5 is a timing chart illustrating an operation in a case where continuation of the long press state is determined by the polling processing by software. Similarly to A to E of FIG. 4, A to E of FIG. 5 illustrate the UX processing, the CPU operating state, the touch state, the measurement by the counter, and the internal processing timing, respectively, in time series.

As illustrated in C of FIG. 5, the touch state is the long press state, but the user's finger is separated from the operation surface only for a very short time between a horizontal bar TS1 and a horizontal bar TS2 indicating the touch state, that is, between time t22 and time t23. In a case where such finger separation in a very short time is to be detected by the polling processing by software, there is a risk of detection omission.

As a countermeasure against the detection omission, it is assumed that the polling interval in the polling processing is set to a high frequency to perform the polling processing with higher accuracy. However, in a case where the polling processing with high accuracy is executed, the CPU 41 is always in a high load state, and power consumption further increases, which causes a large disadvantage from the viewpoint of power consumption. Furthermore, even if the detection omission is dealt with by the polling processing with high accuracy, the possibility of the detection omission of the finger separation in a very short time is not eliminated, and thus, it is a problem that cannot be essentially solved.

As illustrated in C and D of FIG. 5, the detection unit 12A operates as a long press detection circuit, so that counting by the operation time counter 112 is started and the counter value is decremented by finger separation in a very short time from time t22 to time t23. Thereafter, when the counter of the operation time counter 112 expires at time t24, an interrupt notification is generated.

At this time, as indicated by an arrow d2 and an arrow e1 in E of FIG. 5, there is a possibility that the interrupt notification by hardware may be batted against the polling processing by software. In a case where such batting occurs, it is assumed that state management on a software side becomes very complicated. For example, in a case where an interrupt notification of detection of a long press state is generated during execution of the polling processing by software, it is necessary to ignore the interrupt notification and end the polling processing.

As described above, the detection unit 12A in FIG. 2 cannot detect the continuous long press state, and in a case where the continuous long press state is detected by the polling processing by software, there is a possibility that detection of the finger separation in a very short time may be missed, and even if the polling processing is performed with higher accuracy, it is not an essential solution.

### <Second Example of Detection Unit Configuration>

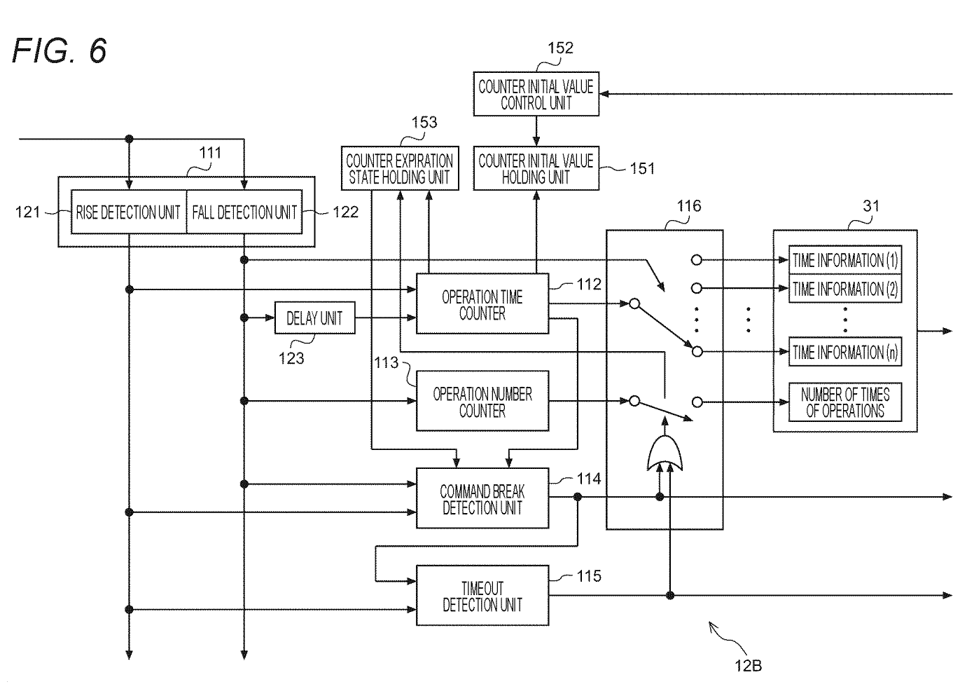

FIG. 6 is a block diagram illustrating a second example of the configuration of the detection unit 12 in FIG. 1.

In FIG. 6, a detection unit 12B is further provided with a counter initial value holding unit 151, a counter initial value control unit 152, and a counter expiration state holding unit 153 in addition to the edge detection unit 111 to the output control unit 116, as compared with the detection unit 12A in FIG. 2. The edge detection unit 111 to the output control unit 116 in FIG. 6 can operate similarly to the edge detection unit 111 to the output control unit 116 in FIG. 2, but different operations will be described below.

When the counter expires, the operation time counter 112 outputs a counter expiration signal to the command break detection unit 114 and the counter expiration state holding unit 153. When receiving the counter expiration signal from the operation time counter 112, the command break detection unit 114 outputs an interrupt (interrupt notification) of the command detection signal to the control unit 13.

The counter initial value holding unit 151 holds an initial value of the operation time counter 112. When the counter expires, the operation time counter 112 initializes the counter with reference to an initial value of the counter held in the counter initial value holding unit 151.

The counter initial value control unit 152 controls the initial value of the counter held in the counter initial value holding unit 151 under the control of the CPU 41. That is, the counter initial value control unit 152 can dynamically change the initial value of the counter referred to by the operation time counter 112 by changing the initial value of the counter held in the counter initial value holding unit 151.

Upon receiving the counter expiration signal from the operation time counter 112, the counter expiration state holding unit 153 holds a counter expiration state indicating that the counter of the operation time counter 112 has expired, and outputs an enable signal to the command break detection unit 114. The command break detection unit 114 is enabled when receiving the enable signal from the counter expiration state holding unit 153.

When receiving the fall detection signal from the fall detection unit 122, the command break detection unit 114 outputs an interrupt (interrupt notification) of the command detection signal to the output control unit 116 and the control unit 13. When receiving the interrupt of the command detection signal from the command break detection unit 114, the output control unit 116 performs control such that the number of times of touch operations read from the operation number counter 113 is output to the register 31 (the number of times of operations is updated), and outputs an initialization signal to the counter expiration state holding unit 153.

Upon receiving the initialization signal from the output control unit 116, the counter expiration state holding unit 153 initializes the held counter expiration state and outputs a disable signal to the command break detection unit 114. When receiving the disable signal from the counter expiration state holding unit 153, the command break detection unit 114 is disabled.

In the detection unit 12B configured as described above, similarly to the detection unit 12A in FIG. 2, the detection unit can operate as at least one of the touch number measurement circuit, the long press detection circuit, and the touch-on/off detection circuit. In the detection unit 12B, each circuit of the touch number measurement circuit, the long press detection circuit, and the touch-on/off detection circuit is realized one by one, and a plurality of the circuits may be realized.

In a case where the detection unit 12B operates as the long press detection circuit, the following operation is different from the case where the detection unit 12A operates as the long press detection circuit. That is, in the detection unit 12B, the operation time counter 112 notifies the command break detection unit 114 of a counter expiration signal at the time of expiration of the counter, so that a notification of an interrupt of the command detection signal is made, and the counter is initialized by referring to the initial value of the counter held in the counter initial value holding unit 151. As a result, the counting by the operation time counter 112, and the interrupt notification and the initialization of the counter at the time of expiration of the counter are repeatedly performed in a period in which the long press state continues.

In other words, in a case where the long press operation is detected as the touch operation, the detection unit 12B notifies the command break detection unit 114 of the counter expiration signal when the counter of the operation time counter 112 expires, so that the command break detection unit 114 detects a command break. Then, in the detection unit 12B, when the command break is detected, the operation time counter 112 initializes the counter by referring to the initial value of the counter held in the counter initial value holding unit 151 to initialize the internal state, and the command break detection unit 114 notifies the CPU 41 of an interrupt according to the continuous long press state.

Furthermore, the detection unit 12B operates as the touch-on/off detection circuit simultaneously with the long press detection circuit, so that the end of the long press state can be reliably detected. In a case where the detection unit 12B operates as the touch-on/off detection circuit in conjunction with the operation of the long press detection circuit, the following operation is different from the case where the detection unit 12A operates as the touch-on/off detection circuit. That is, in the detection unit 12B, the counter expiration state holding unit 153 holds the counter expiration state until the touch-off is detected at the timing at which the long press detection circuit makes a notification of the first interrupt (the timing at which the interrupt is generated even once), and the command break detection unit 114 is enabled. Furthermore, in the detection unit 12B, when the touch-on/off detection circuit detects the touch-off, the counter expiration state is initialized so that the command break detection unit 114 is disabled.

In other words, in the detection unit 12B, in a case where the touch-on and touch-off are detected as the touch operation, the interrupt notification function by the command break detection unit 114 is enabled or disabled according to the counter expiration state of the operation time counter 112 held by the counter expiration state holding unit 153.

### <Improvement>

An improvement of the detection unit 12B in FIG. 6 as compared with the detection unit 12A in FIG. 2 will be described.

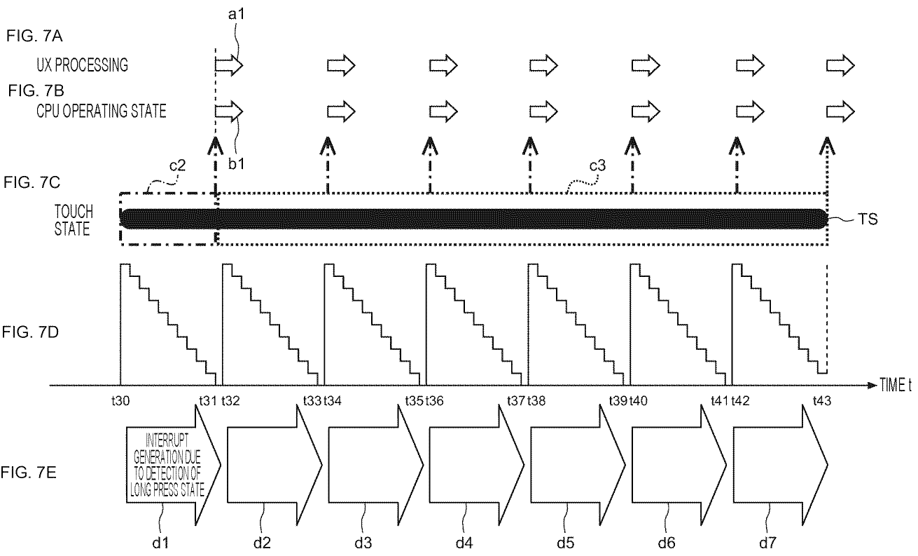

FIG. 7 is a timing chart illustrating an operation in a case where the detection unit 12B in FIG. 6 repeatedly detects a continuous long press state. A to E of FIG. 7 represent the UX processing, the CPU operating state, the touch state, the measurement by the counter, and the internal processing timing, respectively, in time series similarly to A to E of FIGS. 4 and 5.

As illustrated in C and D of FIG. 7, the detection unit 12B operates as the long press detection circuit, and thus, in a period in which the long press state is continued, the measurement of the operation time by the operation time counter 112, and the interrupt notification and the initialization of the counter at the time of expiration of the counter are repeatedly performed (dashed-dotted line rectangle c2).

Specifically, when the long press state is started at time t30, the operation time counter 112 starts counting and continuously decrements the counter value. When the counter of the operation time counter 112 expires at time t31, a notification of an interrupt due to long press state detection is made, and the counter is initialized. In the operation time counter 112, the counter is initialized, the counting is started again at time t32, the counter value is continuously decremented, the counter expires at time t33, and the interrupt notification and the counter initialization are performed.

Thereafter, similarly, the counting by the operation time counter 112, and the interrupt notification and the initialization of the counter at the time of expiration of the counter are performed in each of periods of time t34 to time t35, time t36 to time t37, time t38 to time t39, and time t40 to time t41. That is, by the detection unit 12B operating as the long press detection circuit, the counting by the down counter, and the interrupt notification and the initialization of the counter at the time of expiration of the counter are repeated until the long press state ends.

Furthermore, as illustrated in C and D of FIG. 7, the touch-on/off detection circuit is enabled at the timing when the counter of the operation time counter 112 expires at time t31 and an interrupt is generated by the long press state detection (the timing when the first interrupt is generated), and the detection unit 12B operates as the touch-on/off detection circuit along with the long press detection circuit (dotted rectangle c3). In this way, by the detection unit 12B operating as the touch-on/off detection circuit, a state (touch-off) in which the user's finger is separated from the operation surface is detected at time t43 after the counting is started at time t42, and a notification of the interrupt is made. When the touch-on/off detection circuit detects the touch-off, the end of the long press state is detected.

As illustrated in C of FIG. 3, in the touch-on/off detection circuit, since a notification of the interrupt is made at the timings of the start and end of the touch state, a large number of notifications may be continuously made, and it is often convenient to disable the touch-on/off detection circuit. However, here, the touch-on/off detection circuit is enabled in order to detect the moment when the user moves the finger away from the operation surface. As described above, by enabling the touch-on/off detection circuit at the time of detecting the continuous long press state, it is possible to make a notification of an interrupt only at a necessary and sufficient timing. Furthermore, by disabling the touch-on/off detection circuit after detecting the end of the continuous long press state, it is possible to suppress an unnecessary interrupt notification to the CPU 41.

Even at the timing when the end of the continuous long press state is detected by the hardware, it is possible to appropriately execute the end processing in the UX processing without waste by making a notification of the interrupt. That is, in the case of using the detection unit 12B, since the polling processing by software is not executed, as illustrated in E of FIG. 7, the interrupt notification by hardware (arrows d1 to d7) is not batted against the polling processing by software, and it is sufficient that the end processing for the interrupt notification is performed.

Furthermore, at time t43, an interrupt notification is made at a timing when the end of the long press state is detected by the hardware, and a series of the UX processing can be completed. Therefore, the timing does not differ from the end time of the actual long press state due to the deviation from the polling interval as in the case of executing the polling processing by software, and detection of the finger separation in a very short time is not missed.

As described above, in the detection unit 12B of FIG. 6, even if the long press state continues after the long press state is detected between the time t30 and the time t31 (for example, 3 seconds), the long press state can be continuously detected by the hardware by repeating the interrupt notification and the initialization of the counter at the time of expiration of the counter. That is, in the timing chart of FIG. 4, the long press state is detected only once and a notification of the interrupt is made, and the process is ended. However, in the timing chart of FIG. 7, while the long press state continues, a notification of the interrupt can be made every time the long press state is detected. Therefore, long press determination processing in the polling processing by software is unnecessary, and when a continuous long press state is detected, continuous detection can be performed while keeping the CPU 41 in a sleep state.

As a result, as illustrated in A and B of FIG. 7, a temporal interval of the arrow al and a temporal interval of the arrow b1 can be made the same, and the timing at which the CPU 41 operates can be adjusted to the UX processing. In the electronic device 10, it is possible to drive the CPU 41 only at necessary timing, and as a result, it is possible to easily reduce power consumption and complexity of software design and implementation.

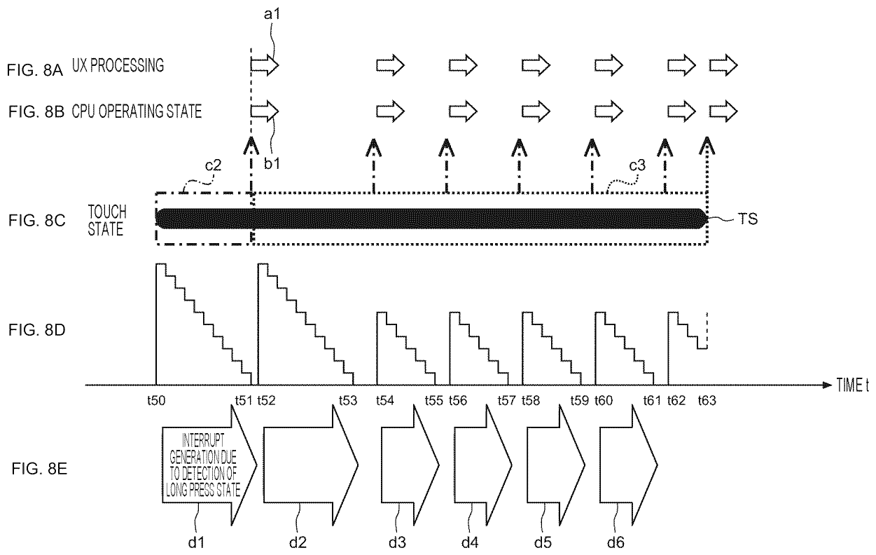

FIG. 8 is a timing chart illustrating an operation in a case where the detection unit 12B in FIG. 6 dynamically changes an initial state in the continuous long press state. Similarly to A to E of FIG. 7, A to E of FIG. 8 illustrate the UX processing, the CPU operating state, the touch state, the measurement by the counter, and the internal processing timing, respectively, in time series.

As illustrated in D of FIG. 8, in the operation time counter 112, the initial value of the counter can be dynamically changed when the counter is initialized at the time of expiration of the counter. Specifically, the initial value of the counter is different between the counting by the down counter at time t50 to time t51 and time t52 to time t53 and the counting by the down counter at time t54 to time t55, time t56 to time t57, time t58 to time t59, and time t60 to time t61.

From time t52 to time t53, when the operation time counter 112 performs the counting operation, the counter initial value control unit 152 changes the initial value of the counter held in the counter initial value holding unit 151. Then, when the counter expires at time t53, the operation time counter 112 initializes the counter value of the counter with reference to the initial value held in the counter initial value holding unit 151.

That is, in a case where the detection unit 12B operates as the long press detection circuit, the counting by the operation time counter 112, and the interrupt notification and the initialization of the counter at the time of expiration of the counter are repeatedly performed, but in a case where the initial value of the counter is dynamically changed, the initial value held in the counter initial value holding unit 151 is changed by the counter initial value control unit 152. Therefore, the operation time counter 112 refers to the changed initial value when initializing the counter, and the initial value of the counter is dynamically changed.

As described above, in the detection unit 12B, by changing a condition of the initialization of the long press detection circuit, the interval of the detection operation of the long press state can be dynamically changed, and a cycle of the interrupt notification can be dynamically changed. Therefore, as illustrated in A and B of FIG. 8, the operating state of the CPU 41 and the timing of the UX processing can be adjusted. Furthermore, since the timing at which a notification of the interrupt is made on a hardware side is adjusted by the detection unit 12B, the CPU 41 only needs to execute processing according to the interrupt, a notification of which is sequentially made, and it is possible to realize a complicated UX by a simple software design while maintaining low power consumption without increasing the load of the CPU 41.

### Specific Configuration Example

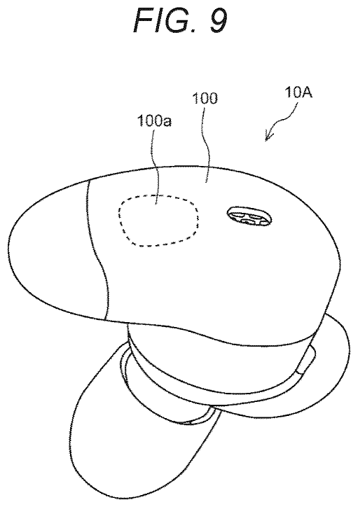

FIG. 9 is a diagram illustrating an external configuration example of a wireless earphone 10A to which the present disclosure is applied.

The wireless earphone 10A is an example of the electronic device 10. The wireless earphone 10A will be described as a true wireless earphone conforming to the Bluetooth (registered trademark) communication standard. In general, a true wireless earphone is a slave device that functions in cooperation with a master device such as a smartphone or a portable music player. The wireless earphone 10A is not limited to the slave device, and may function as a single device.

As illustrated in FIG. 9, the appearance of the wireless earphone 10A is substantially defined by an earpiece-like housing 100 that is molded so as to conform to a shape of the human outer ear. In FIG. 9, only one of a pair of earpieces is illustrated. Furthermore, although not illustrated, a power supply, a control LSI chip, and the like are accommodated inside the housing 100.

A part of a surface of the housing 100 is an operation surface 100a, and is configured to function as a touch sensor sensitive to a touch operation by the user. The user can give a command to a master device such as a smartphone via the wireless earphone 10A by performing various touch operations on the operation surface 100a of the housing 100.

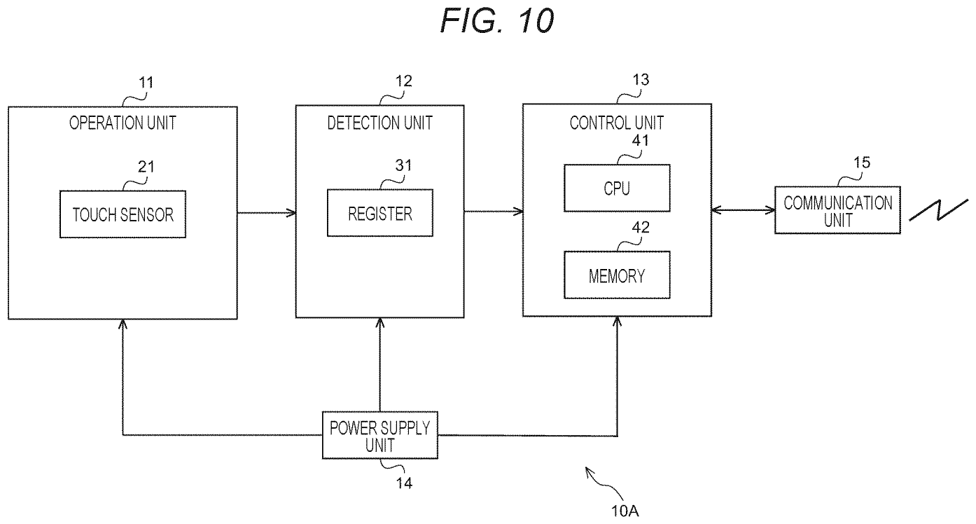

FIG. 10 is a block diagram illustrating a configuration example of the wireless earphone 10A in FIG. 9.

In FIG. 10, the wireless earphone 10A is further provided with a communication unit 15 in addition to the operation unit 11 to the power supply unit 14, as compared with the electronic device 10 in FIG. 1.

The communication unit 15 is configured as a communication module that performs wireless communication conforming to the Bluetooth (registered trademark) communication standard with another device, for example, a master device such as a smartphone. The communication unit 15 operates in accordance with control from the control unit 13. In FIG. 10, the communication unit 15 is configured separately from the control unit 13, but may be configured as a chipset of a processor module.

The detection unit 12 has a configuration corresponding to the detection unit 12B in FIG. 6, and in addition to the edge detection unit 111 to the output control unit 116, a counter initial value holding unit 151, a counter initial value control unit 152, and a counter expiration state holding unit 153 are further provided.

In the wireless earphone 10A configured as described above, when the user performs a touch operation such as a tap operation or a long press operation on the operation surface 100a of the housing 100 in a case where the wireless earphone 10A is paired and operated with a master device such as a smartphone, a command is transmitted to the master device, and various functions are implemented.

The tap operation is an operation in which the user touches the operation surface 100a by lightly tapping the operation surface with a fingertip. An operation of tapping only once is referred to as a single tap operation, an operation of tapping quickly twice is referred to as a double tap operation, and an operation of tapping quickly three times is referred to as a triple tap operation. For example, the single tap operation may be a reproduction/pause command for an application, such as a music reproduction app executed on a smartphone. The double tap operation may be a cue command for a next song, and the triple tap operation may be a cue command for a previous song or a song being reproduced.

The long press operation is an operation in which the user's finger touches the operation surface 100a for a certain period of time and then releases it. In the long press operation, the contact time of the user's finger with respect to the operation surface 100a becomes longer than in the tap operation. For example, the long press operation may be a volume adjustment command such as volume up or volume down for an application executed on a smartphone, a fast forward (FF) command, or a fast rewind (FR) command. Hereinafter, a case where volume up processing and FF processing are executed as the UX processing by the long press operation of the user will be exemplified.

### <Volume Up Processing>

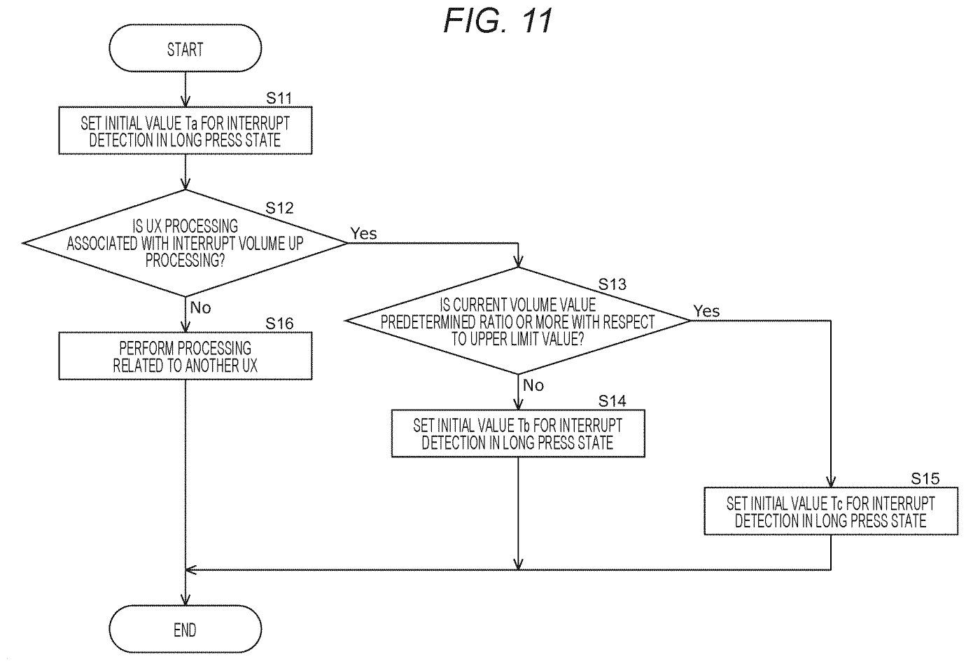

In the volume up processing, while the user continues the long press operation, processing for increasing the volume of the music being reproduced by an application such as a music reproducing application is executed. A flow of the volume up processing executed by the wireless earphone 10A will be described with reference to a flowchart of FIG. 11.

In step S11, the counter initial value control unit 152 sets an initial value Ta for interrupt detection in the long press state as an initial value of the counter held in the counter initial value holding unit 151. For example, the initial value Ta is set to 3 seconds.

In step S12, it is determined whether or not the UX processing associated with the generated interrupt is the volume up processing. In a case where it is determined in step S12 that the UX processing is the volume up processing, the processing proceeds to step S13. In step S13, it is determined whether or not the current volume value is a predetermined ratio or more with respect to an upper limit value. For example, the predetermined ratio is 80%.

In a case where it is determined in step S13 that the current volume value is less than the predetermined ratio (for example, less than 80%), the processing proceeds to step S14. In step S14, the counter initial value control unit 152 sets an initial value Tb for interrupt detection in the long press state as an initial value of the counter held in the counter initial value holding unit 151. For example, the initial value Tb is 300 milliseconds.

On the other hand, in a case where it is determined in step S13 that the current volume value is greater than or equal to the predetermined ratio (for example, greater than or equal to 80%), the processing proceeds to step S15. In step S15, the counter initial value control unit 152 sets an initial value Tc for interrupt detection in the long press state as an initial value of the counter held in the counter initial value holding unit 151. For example, the initial value Tc is set to 1 second.

In a case where it is determined in step S12 that the UX processing associated with the interrupt is not the volume up processing, the processing proceeds to step S16, and processing related to another UX processing is performed. When the processing in any one of steps S14 to S16 ends, the series of processing ends.

Here, by repeatedly performing the processing of steps S12 to S15 while the long press operation by the user is continued, as the initial value of the counter held in the counter initial value holding unit 151, control is repeatedly performed such that, in a case where the current volume value is less than 80% of the upper limit value, 300 milliseconds is set as the initial value Tb, and in a case where the current volume value is greater than or equal to 80% of the upper limit value, 1 second is set as the initial value Tc.

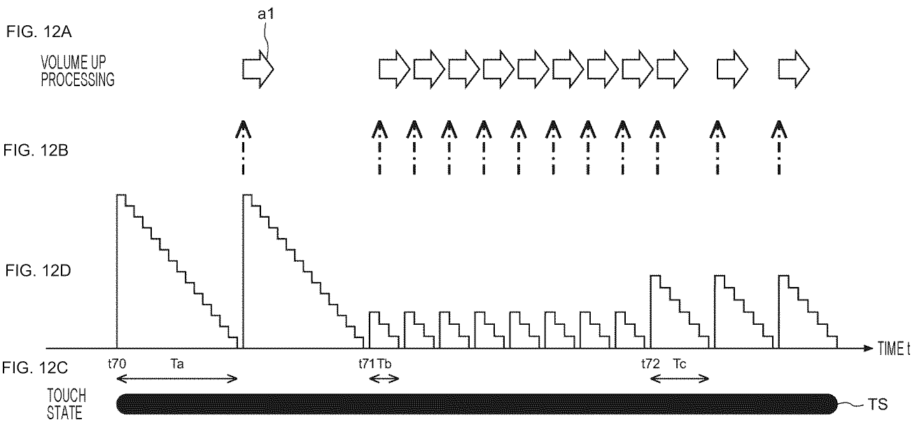

A timing chart of FIG. 12 illustrates the timing of the volume up processing when the initial value of the counter is dynamically changed in the continuous long press state. A to D of FIG. 12 illustrate the volume up processing, the interrupt notification, the touch state, and the measurement by the down counter, respectively, in time series.

As illustrated in B to D of FIG. 12, in a period in which the long press state continues, the measurement of the operation time by the operation time counter 112 (down counter), and the interrupt notification and the initialization of the down counter at the time of expiration of the down counter are repeatedly performed. When initialization of the down counter is performed at the time of expiration of the down counter, the initial value of the down counter is dynamically changed.

Specifically, since an initial value Ta of 3 seconds is initially set as the initial value of the down counter held in the counter initial value holding unit 151 (S11 in FIG. 11), the countdown with 3 seconds as the initial value is performed in the two measurements repeated after time t70.

Thereafter, an initial value Tb of 300 milliseconds is set as the initial value of the counter according to a ratio of the current volume value to the upper limit value of the volume (S14 in FIG. 11), and in eight times of the measurement repeated after time t71, countdown with 300 milliseconds as the initial value is performed. Thereafter, an initial value Tc of 1 second is set as the initial value of the counter according to the ratio of the current volume value to the upper limit value of the volume (S15 in FIG. 11), and in three times of measurement repeated after time t72, countdown with 1 second as the initial value is performed.

In this manner, the initial value of the down counter is dynamically changed to the initial value Ta, the initial value Tb, and the initial value Tc, so that it is possible to dynamically change the cycle of the interrupt, a notification of which is made at the time of expiration of the counter, as illustrated in B of FIG. 12. In A of FIG. 12, the timing at which the volume up processing is executed is indicated by an arrow al. By executing the volume up processing according to the interrupt notification, it is possible to easily realize control to make the change of the volume value gradual or abrupt according to the ratio of the current volume value to the upper limit value of the volume.

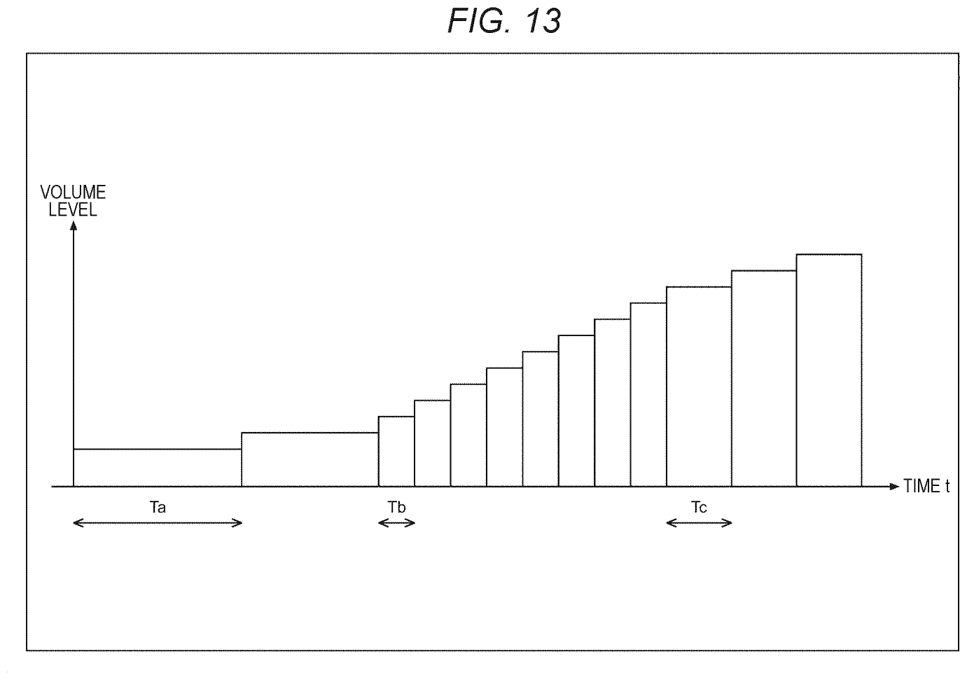

FIG. 13 is a diagram illustrating a change in a volume value by the volume up processing of FIG. 12. In FIG. 13, the horizontal axis represents time, and the vertical axis represents a volume level.

As illustrated in FIG. 13, the initial value of the down counter is dynamically changed to the initial value Ta, the initial value Tb, and the initial value Tc according to the ratio of the current volume value to the upper limit value of the volume, so that the cycle of the interrupt, a notification of which is made at the time of expiration of the counter, is dynamically changed. Therefore, the period until the volume level rises is different for each time zone.

That is, in a case where the current volume value is far from the upper limit value (for example, in a case of an intermediate volume region), the initial value Tb of 300 milliseconds is set, so that the UX response is increased and the volume change becomes steep. On the other hand, in a case where the current volume value reaches the vicinity of the upper limit value, in order to reduce a burden on the user's ear due to the sound pressure change, the initial value Tc of 1 second is set so that the change in volume becomes gentle.

### <FF Processing>

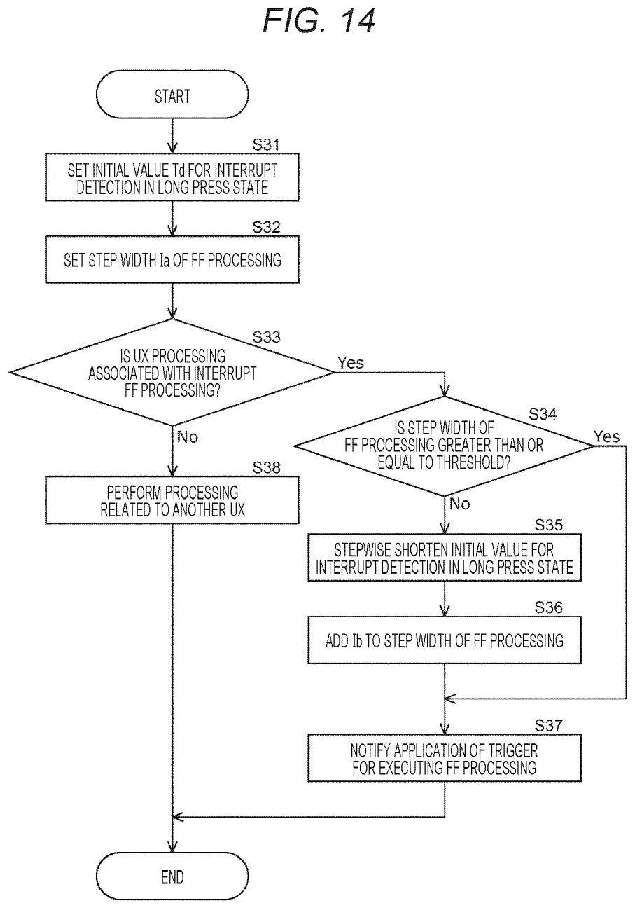

In the FF processing, while the user continues the long press operation, processing for fast forwarding the music being reproduced by an application such as a music reproducing application is executed. A flow of the FF processing executed by the wireless earphone 10A will be described with reference to a flowchart of FIG. 14.

In step S31, the counter initial value control unit 152 sets an initial value Td for interrupt detection in the long press state as the initial value of the counter held in the counter initial value holding unit 151. Furthermore, in step S32, the CPU 41 sets a step width Ia of the FF processing. For example, the initial value Td is set to 3 seconds, and the step width Ia is set to 15 seconds.

In step S33, it is determined whether or not the UX processing associated with the generated interrupt is the FF processing. In a case where it is determined in step S33 that the UX processing is the FF processing, the processing proceeds to step S34. In step S34, it is determined whether or not the step width of the FF processing is greater than or equal to a threshold.

In a case where it is determined in step S34 that the step width of the FF processing is less than the threshold, the processing proceeds to step S35. In step S35, the counter initial value control unit 152 stepwise shortens the initial value for interrupt detection in the long press state held in the counter initial value holding unit 151.

In step S36, the CPU 41 adds the addition value Ib to the step width of the FF processing. For example, the addition value Ib is set to 15 seconds. In step S37, the CPU 41 notifies an application such as a music reproducing application of a trigger for executing the FF processing. In a case where it is determined in step S34 that the step width of the FF processing is greater than or equal to the threshold, the processing of steps S35 to S36 is skipped, and a notification of the trigger for executing the FF processing is made (S37).

In a case where it is determined in step S33 that the UX processing associated with the interrupt is not the FF processing, the processing proceeds to step S38, and processing related to another UX is performed. When the processing of step S37 or S38 ends, the series of processing ends.

Here, by repeatedly performing the processing of steps S33 to S37 while the long press operation by the user is continued, in a case where the step width of the FF processing is less than the threshold, the initial value of the counter held in the counter initial value holding unit 151 is stepwise shortened (for example, 3 seconds, 2 seconds, 1 second, 500 milliseconds, 300 milliseconds, . . . ), and control of adding the addition value Ib (for example, 15 seconds) to the step width of the FF processing is repeatedly performed.

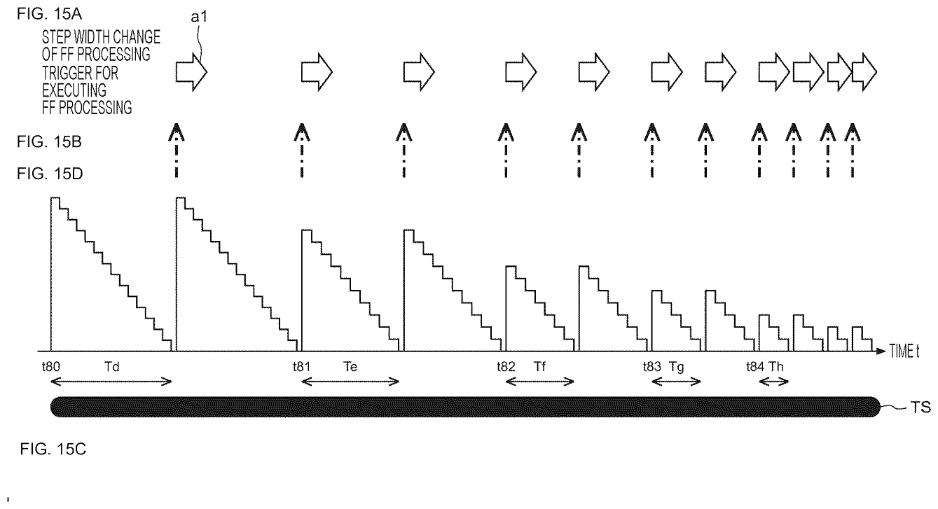

A timing chart of FIG. 15 illustrates a timing of the FF processing when the initial value of the counter is dynamically changed in the continuous long press state. A to D of FIG. 15 illustrate the FF processing, the interrupt notification, the touch state, and the measurement by the down counter, respectively, in time series.

As illustrated in B to D of FIG. 15, in a period in which the long press state continues, the measurement of the operation time by the operation time counter 112 (down counter), and the interrupt notification and the initialization of the down counter at the time of expiration of the down counter are repeatedly performed. When initialization of the down counter is performed at the time of expiration of the down counter, the initial value of the down counter is dynamically changed.

Specifically, since an initial value Td of 3 seconds is initially set as the initial value of the down counter held in the counter initial value holding unit 151 (S31 in FIG. 14), in the two measurements repeated after time t80, the countdown with 3 seconds as the initial value is performed.

Thereafter, the initial value of the counter is set to be stepwise shortened according to the step width of the FF processing (S35 in FIG. 14). That is, in two measurements repeated after time t81, a countdown with Te of 2 seconds as an initial value is performed, and in two measurements repeated after time t82, a countdown with Tf of 1 second as an initial value is performed. Furthermore, in two measurements repeated after time t83, a countdown with Tg of 500 milliseconds as an initial value is performed, and in two measurements repeated after time t84, a countdown with Th of 300 milliseconds as an initial value is performed. Thereafter, similarly, the measurement is repeated while the initial value of the down counter is stepwise shortened, but the description will be omitted.

As described above, the initial value of the down counter is changed to be stepwise shortened, such as the initial value Td, the initial value Te, the initial value Tf, the initial value Tg, and the initial value Th, so that it is possible to dynamically change the cycle of the interrupt, a notification of which is made at the time of expiration of the counter in proportion to the duration of the long press state as illustrated in B of FIG. 15.

In A of FIG. 15, the timing at which the step width of the FF processing is changed and the trigger for executing the FF processing is executed is indicated by an arrow al. Here, in a case where a notification of the interrupt is made, the step width of the FF processing per unit time is changed (S36 in FIG. 14), so that it is possible to easily perform control such that the step width of the FF processing increases at an acceleration rate during a period in which the long press state continues. That is, the step width of the FF processing can be increased in an acceleration rate only by increasing the generation frequency (generation density) of the interrupt notification. After the step width of the FF processing is changed, a notification of a trigger for executing the FF processing is made to the application (S37 in FIG. 14).

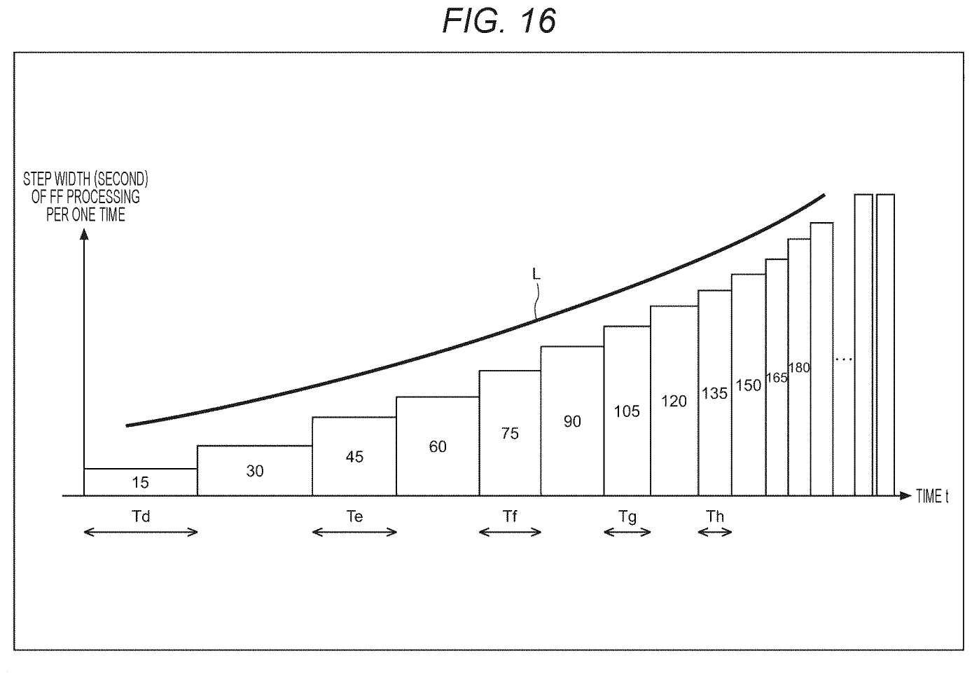

FIG. 16 is a diagram illustrating a change in the step width of the FF processing of FIG. 15. In FIG. 16, the horizontal axis represents time, and the vertical axis represents the step width (unit: second) of the FF processing per one time.

As illustrated in FIG. 16, the initial value of the down counter is changed to be stepwise shortened such as the initial value Td, the initial value Te, the initial value Tf, the initial value Tg, and the initial value Th according to the threshold determination result of the step width of the FF processing, whereby the cycle of the interrupt, a notification of which is made at the time of expiration of the counter, is stepwise shortened. Furthermore, an addition value is added to the step width of the FF processing every time a notification of the interrupt is made.

That is, in a case where 15 seconds is set as the step width Ia of the FF processing and 15 seconds is set as the addition value Ib, the step width of the FF processing is added by 15 seconds at a time to the step width of the FF processing according to the interrupt notification in which the generation frequency gradually increases in a period in which the long press state continues, and thus the step width of the FF processing increases in an acceleration rate. In FIG. 16, the numerical value on the bar graph represents the step width of the FF processing per one time, and the step width that is first 15 seconds increases by 30 seconds, 45 seconds, 60 seconds, 75 seconds, 90 seconds, 105 seconds, 120 seconds, 135 seconds, 150 seconds, 165 seconds, 180 seconds, . . . , and 15 seconds with the lapse of time, but the time until the step width increases becomes shorter as the duration of the long press state becomes longer.

As described above, by dynamically changing the cycle of the interrupt, a notification of which is made from the hardware in proportion to the duration of the long press state, as indicated by a curve L in FIG. 16, the step width of the FF processing per unit time can be increased in an acceleration rate, and the FF processing at an accelerated rate can be easily realized.

### Modifications

In the above description, in a case where the detection unit 12B operates as the long press detection circuit, the operation time counter 112 is used as a counter for detecting the long press state. However, another detection unit (another detection circuit) may be used. Similarly, in a case where the long press state is detected by another detection unit, when a command break is detected by another detection unit (for example, another counter) (for example, when another counter expires), the internal state is initialized (for example, another counter is initialized), so that a notification of an interrupt can be made for the continuous long press state.

In the above description, in a case where the detection unit 12B operates as the touch-on/off detection circuit in conjunction with the operation of the long press detection circuit, the command break detection unit 114 that generates an interrupt when receiving the rise detection signal or the fall detection signal is dynamically enabled or disabled. However, the present disclosure is not limited to the touch-on/off detection circuit, and one or a plurality of other detection units (other detection circuits) may be dynamically enabled or disabled.

In the electronic device 10 of FIG. 1, the operation unit 11 configured as a user interface circuit is not limited to the configuration to detect the physical contact of the user's finger or the like (part of the body part), and may be configured to detect, for example, a state in which the user's finger or the like approaches. Furthermore, the operation surface is not limited to the housing surface, and may be an object such as a surface that a user's finger or the like can touch.

The electronic device 10 is not limited to the wireless earphone 10A, and may be another device as long as the device can perform a touch operation. In the above description, the volume adjustment of the music being reproduced by the application such as the music reproducing application and the long press operation of the fast forward (FF) are exemplified. However, the present disclosure is applicable not only to the music content but also to the long press operation instructing the volume adjustment, the fast reverse, and the like of other content such as a video content.

The processing in each step in the flowcharts described above can be performed by hardware, or can be performed software. In a case where the series of processing is executed by software, a program constituting the software is installed in the electronic device 10 (computer). Here, in the present description, the processing to be performed by the computer in accordance with the program is not necessarily performed in time series according to orders described in the flowcharts. In other words, the processing to be performed by the computer in accordance with the program includes processing to be performed in parallel or independently of one another (parallel processing or object-based processing, for example).

Note that embodiments of the present disclosure are not limited to the embodiments described above, and various modifications may be made without departing from the scope of the present disclosure. Furthermore, the effects described in the present description are merely examples and are not limited, and other effects may be provided.

Furthermore, the present disclosure can have the following configurations.

(1)

An electronic device including:
an operation unit that outputs an operation signal according to a touch operation by a user;
a detection unit that detects a command according to the touch operation on the basis of the output operation signal; and
a control unit that executes processing according to the detected command,
in which in a case of detecting a long press operation as the touch operation, the detection unit initializes an internal state and notifies the control unit of an interrupt according to a continuous long press state when detecting a break of the command, and
the control unit executes processing according to the notified interrupt.
   (2)

The electronic device according to (1) described above, in which
the detection unit includes:
   an operation time counter that measures a time of the touch operation; and
   a counter initial value holding unit that holds an initial value of the operation time counter, and
initializes the operation time counter to the initial value held in the counter initial value holding unit and makes a notification of the interrupt when the operation time counter expires.
   (3)

The electronic device according to (2) described above, in which
the detection unit further includes
   a counter initial value control unit that dynamically changes the initial value held in the counter initial value holding unit, and
changes a cycle of the interrupt to be notified according to the dynamically changed initial value.
   (4)

The electronic device according to (2) or (3) described above, in which
the detection unit further includes
   a counter expiration state holding unit that holds an expiration state of the operation time counter, and
enables or disables a notification function of the interrupt according to the expiration state of the operation time counter.
   (5)

The electronic device according to (4) described above, in which
the detection unit further includes
   a command break detection unit that detects a break of the command and makes a notification of the interrupt according to the detected break of the command, the command break detection unit making a notification of the interrupt according to timings at which start and end of a touch state are detected on the basis of the operation signal, and
enables or disables the command break detection unit according to the expiration state of the operation time counter.
   (6)

The electronic device according to (5) described above, in which
the detection unit further includes
   an operation number counter that measures a number of times of the touch operations, and
enables the command break detection unit when the operation time counter is in the expiration state, and disables the command break detection unit when the command break detection unit makes a notification of the interrupt and the number of times of the operations measured by the operation number counter is updated.
   (7)

The electronic device according to any one of (3) to (6) described above, in which
the control unit includes a central processing unit (CPU),
the CPU operates according to the interrupt to be notified, and
user experience (UX) processing is executed according to an operating state of the CPU.
   (8)

The electronic device according to (7) described above, in which
the UX processing includes volume adjustment processing of adjusting a sound volume of content, and
the CPU controls the initial value to be dynamically changed on the basis of a relationship between a volume upper limit value and a current volume value.
   (9)

The electronic device according to (7) described above, in which
the UX processing includes reproduction speed adjustment processing of adjusting a reproduction speed of content, and
the CPU controls, on the basis of a step width per unit time when the reproduction speed is adjusted, the initial value and the step width to be dynamically changed.
   (10)

The electronic device according to any one of (1) to (9) described above, in which
the detection unit
   detects a time and a number of times of the touch operations on the basis of the output operation signal, and
   includes a register that holds the detected time and number of times of the touch operations, and
the control unit transmits a command based on the time and the number of times of the touch operations acquired from the register to an external device.
   (11)

A control method in an electronic device including:
an operation unit that outputs an operation signal according to a touch operation by a user;
a detection unit that detects a command according to the touch operation on the basis of the output operation signal; and
a control unit that executes processing according to the detected command, the control method including:
in a case where the detection unit detects a long press operation as the touch operation, initializing an internal state and notifying the control unit of an interrupt according to a continuous long press state when the detection unit detects a break of the command; and
executing, by the control unit, processing according to the notified interrupt.

### REFERENCE SIGNS LIST

10 Electronic device
10A Wireless earphone
11 Operation unit
12, 12A, 12B Detection unit
13 Control unit
14 Power supply unit
15 Communication unit
21 Touch sensor
31 Register
41 CPU
42 Memory
111 Edge detection unit
112 Operation time counter
113 Operation number counter
114 Command break detection unit
115 Timeout detection unit
116 Output control unit
121 Rise detection unit
122 Fall detection unit
123 Delay unit
151 Counter initial value holding unit
152 Counter initial value control unit
153 Counter expiration state holding unit

1. An electronic device comprising:
an operation unit that outputs an operation signal according to a touch operation by a user;
a detection unit that detects a command according to the touch operation on a basis of the output operation signal; and
a control unit that executes processing according to the detected command,
wherein in a case of detecting a long press operation as the touch operation, the detection unit initializes an internal state and notifies the control unit of an interrupt according to a continuous long press state when detecting a break of the command, and
the control unit executes processing according to the notified interrupt.

2. The electronic device according to claim 1, wherein
the detection unit includes:
an operation time counter that measures a time of the touch operation; and
a counter initial value holding unit that holds an initial value of the operation time counter, and
initializes the operation time counter to the initial value held in the counter initial value holding unit and makes a notification of the interrupt when the operation time counter expires.

3. The electronic device according to claim 2, wherein
the detection unit further includes
a counter initial value control unit that dynamically changes the initial value held in the counter initial value holding unit, and
changes a cycle of the interrupt to be notified according to the dynamically changed initial value.

4. The electronic device according to claim 2, wherein
the detection unit further includes
a counter expiration state holding unit that holds an expiration state of the operation time counter, and
enables or disables a notification function of the interrupt according to the expiration state of the operation time counter.

5. The electronic device according to claim 4, wherein
the detection unit further includes
a command break detection unit that detects a break of the command and makes a notification of the interrupt according to the detected break of the command, the command break detection unit making a notification of the interrupt according to timings at which start and end of a touch state are detected on a basis of the operation signal, and
enables or disables the command break detection unit according to the expiration state of the operation time counter.

6. The electronic device according to claim 5, wherein
the detection unit further includes
an operation number counter that measures a number of times of the touch operations, and
enables the command break detection unit when the operation time counter is in the expiration state, and disables the command break detection unit when the command break detection unit makes a notification of the interrupt and a number of the operations measured by the operation number counter is updated.

7. The electronic device according to claim 3, wherein
the control unit includes a central processing unit (CPU),
the CPU operates according to the interrupt to be notified, and
user experience (UX) processing is executed according to an operating state of the CPU.

8. The electronic device according to claim 7, wherein
the UX processing includes volume adjustment processing of adjusting a sound volume of content, and
the CPU controls the initial value to be dynamically changed on a basis of a relationship between a volume upper limit value and a current volume value.

9. The electronic device according to claim 7, wherein
the UX processing includes reproduction speed adjustment processing of adjusting a reproduction speed of content, and
the CPU controls, on a basis of a step width per unit time when the reproduction speed is adjusted, the initial value and the step width to be dynamically changed.

10. The electronic device according to claim 1, wherein
the detection unit
detects a time and a number of times of the touch operations on a basis of the output operation signal, and
includes a register that holds the detected time and number of times of the touch operations, and
the control unit transmits a command based on the time and the number of times of the touch operations acquired from the register to an external device.

11. A control method in an electronic device including:
an operation unit that outputs an operation signal according to a touch operation by a user;
a detection unit that detects a command according to the touch operation on a basis of the output operation signal; and
a control unit that executes processing according to the detected command, the control method comprising:
in a case where the detection unit detects a long press operation as the touch operation, initializing an internal state and notifying the control unit of an interrupt according to a continuous long press state when the detection unit detects a break of the command; and
executing, by the control unit, processing according to the notified interrupt.
